(19) United States
(12) Patent Application Publication
(10) Pub. No.: US 2005/0102291 A1
(43) Pub. Date: May 12, 2005

(54) Apparatus and method providing distributed access point authentication and access control with validation feedback

(76) Inventors: Andrew J. Czuchry JR., Auburn, GA (US); William L. Florence III, Athens, GA (US)

Correspondence Address: W. EDWARD RAMAGE, COMMERCE CENTER SUITE 1000, 211 COMMERCE ST, NASHVILLE, TN, 37201, US

(21) Appl. No.: 10/986,972

(22) Filed: Nov. 12, 2004

Related U.S. Application Data
(60) Provisional application No. 60/519,231, filed on Nov. 12, 2003.

(51) Int. Cl. G06F 17/30

(52) U.S. Cl. 707/10

(57) ABSTRACT

A system for distributed access point authentication and access control with validation feedback. Demographic data and access control logic regarding individuals seeking access to one or more control spaces is stored in a core data storage device or database operably connected to a computer. A portion of this data is extracted by a content extraction control module, encapsulated in one or more distribution modules, and distributed to one or more access control points. Individuals present requests for access at or through the access control points, and obtain access if they are authorized. Feedback about access authorization attempts is sent to feedback modules and stored in staging databases. The core data storage device or database subsequently is updated with the information about access authorization attempts.

This application claims priority to Provision Application No. 60/519,231, filed Nov. 12, 2003, by Andrew J. Czuchry, Jr., PhD, and William L. Florence incorporated herein by reference, and is entitled to the filing date thereof for priority.

### TECHNICAL FIELD

The present invention relates to devices and methods for permitting authorized access to controlled spaces. More particularly, the present invention relates to devices and methods for individualized authentication and access control, particularly in non-networked environments.

### BACKGROUND OF THE INVENTION

Single use tickets or entry passes of various types are used for permitting authorized access to controlled spaces. Two examples of such applications include (a) electronic tickets which must be validated at ticketed events, and (b) secure access point (SAP) controls. SAP controls are particularly of use at non-networked locations, such as homeland security checkpoints at transportation facilities.

As electronic ticketing and digital authentication become more prevalent in providing access to controlled spaces, data security and integrity become a significant issue in the overall effectiveness of the authentication and access control procedures. Authentication and access control procedures evaluate whether the individual seeking access to a controlled space is a person authorized to be granted access. Typically one of two scenarios evolves, either (a) nonuser-specific data is authenticated in order to proceed with providing access to a controlled space, or (b) user-specific data is authenticated for providing access to the controlled space. In the first case, the nonuser-specific data may involve an admission ticket, such as for a sporting event, where the individual attendee is unknown but access is sought pursuant to the ticket. In such circumstances, the bearer of the ticket is granted access upon validation or authentication of the admission ticket. Of course, the security risk with this method is substantial, depending on the restrictions placed on who can obtain tickets, and how well the tickets are protected.

In the second case, user-specific data is authenticated using demographic information that must be stored in an authenticating database. While this provides more protection than in the first case, this method also presents drawbacks, such as a security risk if the database were compromised. Demographic information for authentication at a remote location needs to be networked to a central authentication database; however, it is not always feasible to provide this networking, given some access point configurations and/or locations.

Furthermore, such data file transmissions are complicated by the passage of various federal statutes concerning privacy and accountability, such as the Sarbanes-Oxley Act, the Gramm-Leach-Bliley Act (GLBA), and the Health Insurance Portability and Accountability Act of 1996 (HIPAA). The Sarbanes-Oxley Act addresses corporate disclosure and accountability. The GLBA requires financial service firms to implement and enforce an “information security program” to protect non-public customer data. And the Administrative Simplification provisions of HIPAA requires the Department of Health and Human Services to establish national standards for electronic health care transactions, and addresses the security and privacy of health data. Compliance with the HIPAA privacy rules, which insures that health care entities implement appropriate safeguards to protect the privacy of protected health information in both electronic and non-electronic form, is already required. The final security regulations promulgated under HIPAA were published Feb. 20, 2003, in the Federal Register, and will become effective for enforcement purposes on Apr. 25, 2005. The security rules only apply to protected health information in electronic form, and set forth specific standards that must be implemented by covered entities.

As a result, there is a need in the art for an apparatus and method for maintaining user-specific authentication and access control while also providing a mechanism wherein no demographic information is stored in the authenticating database (for example, with homeland security applications where the actual authenticated user's identity may need to be protected). The present invention addresses this need in the art.

### SUMMARY OF THE INVENTION

This invention is directed to a distributed access point authentication and access control system with validation feedback. In one exemplary embodiment, the system comprises a core data storage device or database operably connected to a computer. The database stores demographic data and access control logic regarding persons authorized to have access to one or more control spaces. A subset of this data is extracted by a content extraction control module, and encapsulated in one or more distribution modules. The distribution modules are then distributed to one or more access control points, through which individuals seek access to the control spaces. Individuals present requests for access at or through the access control points, and obtain access if they are authorized.

In another exemplary embodiment, the distribution modules provide feedback about access authorization attempts to feedback modules. Information about access authorization attempts is stored in staging databases in communication with the feedback modules. The core data storage device or database subsequently is updated with the information about access authorization attempts.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 is a schematic diagram of a distributed access point authentication and access control with validation feedback apparatus according to the present invention.

FIG. 2 is a flow chart illustrating processing of the distributed access point authentication and access control with validation feedback.

### DETAILED DESCRIPTION

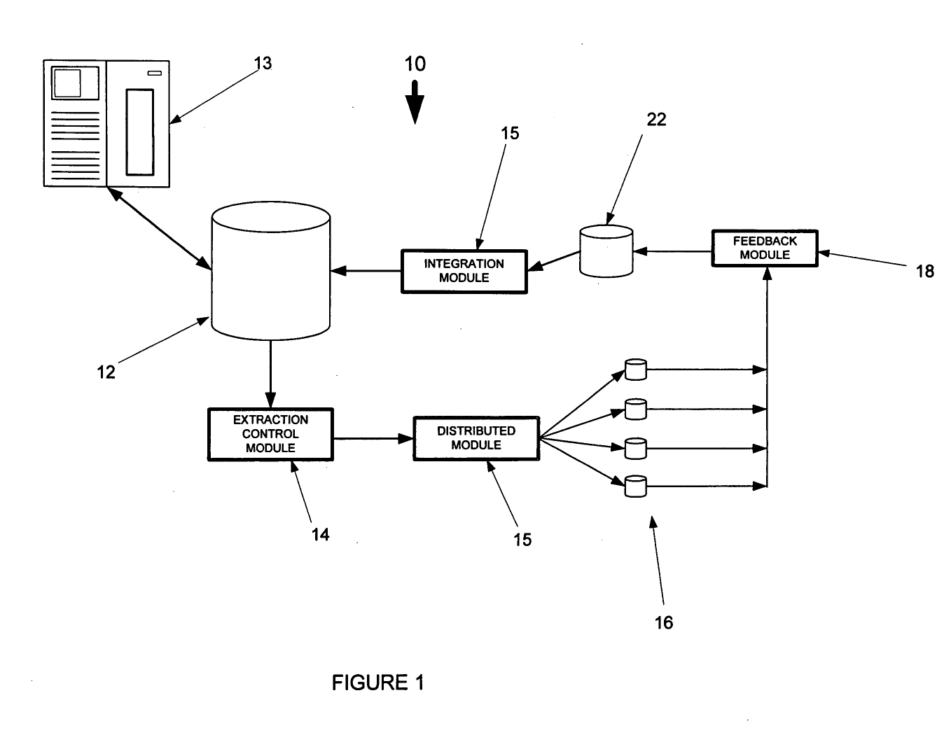

Referring now in more detail to the drawings in which like parts have like identifiers, FIG. 1 is a schematic illustration of an apparatus 10 for distributed access point authentication and access control with validation feedback according to the present invention. The apparatus 10 includes a core data storage device, such as a database, 12 operably connected or linked to a computer 13. The core data storage device or database 12 comprises a secure, centralized database containing appropriate demographic data and access control logic by which persons are both identified and authorized to have access to control spaces. In one exemplary embodiment, the demographic data includes identification of individuals by name, address, and appropriate tracking or identification indicia, among other confidential and limited access information. The access control logic identifies the control space authorized for access by the particular individual.

A content extraction control module 14 communicates with the core data storage device or database 12. The content extraction control module 14 functions to “scrub” the demographic data and access control logic by removing confidential information. This amount of “scrubbing” is dependent upon the requirements of the particular access location. In an exemplary embodiment, the scrubbing process results in scrubbed information that has no information value on its own unless coupled to the demographic data and to the access control logic. Thus, if the scrubbed information is compromised, the information would not be useful to the person or entity obtaining unauthorized access to said information.

A distributed module program 15 encapsulates and stores the scrubbed demographic data and authentication control logic in one or more encapsulated distributed modules for distribution to one of a plurality of remote access locations 16. In an exemplary embodiment, an encrypted and encapsulated distributed module 16 may include a key such as private key in an access lock-and-key infrastructure. The authorized person is provided with a key which matches the lock. The person presents the key at the access control point for the control space to which entry is desired, and if the key matches the lock, access is granted.

The distributed modules at the remote access locations 16, which include, for example, databases of the scrubbed information and encapsulated modules, communicate through secure linkages from the content extraction control module 14 to the access control point (for example, an airport security gateway). The distributed modules at the remote access locations 16 process the access control authentication at the access location. The distributed modules at the remote access locations 16 are fundamental to the authentication and access control at the access control point. However, these access point modules 16 contain no demographic information. Rather, the access point modules 16 are seeking presentation of the appropriate key by persons seeking permitted access to the controlled space.

A feedback module 18 communicates with each of the access point distributed modules 16. The feedback module 18 receives asynchronous data feeds of authentication data from the distributed modules 16. The feedback module 18 communicates with a staging database 22, such as, for example, a server computer within a intranet or internet telecommunications network. The staging database 22 isolates the interaction of the scrubbed data in the distributed module 16 from the secure core data database 12. The staging database 22 receives and stores the scrubbed authentication data results indicating attempted access and granted access responsive to authentication of the access request.

An integration module 24 periodically communicates with the staging database 22 and updates the core database 12 with the scrubbed authentication data results. The demographic data is only identifiable through the integration module 24 returning the authentication data results from the staging database 22 as a validation feedback mechanism in order to update the entries in the secure core database 12.

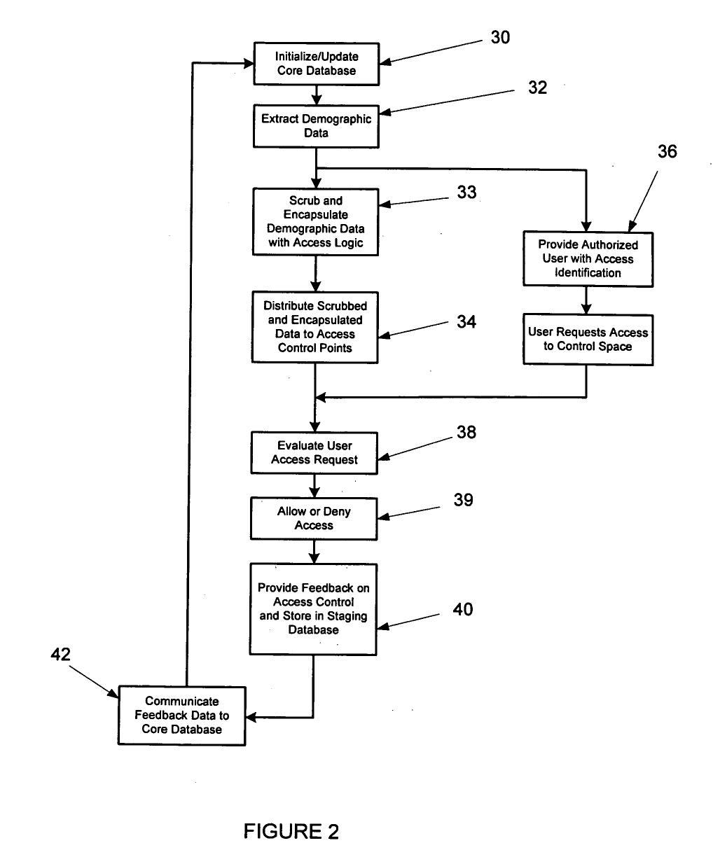

FIG. 2 illustrates a flow chart processing of the distributed access point authentication and access control with validation feedback apparatus 10. The information in the core database 12 is periodically initialized and/or updated 30. The information includes demographic information related to a particular user who will seek access through a control point 16, updated such information, or updated feedback information relating to attempted and granted access to the controlled space through one of the access points using the scrubbed and encapsulated information. Periodically, the demographic and access logic information is extracted, 32, scrubbed and encapsulated 33. The scrubbed and encapsulated information is distributed 34 to the access control points 16. The communication is through network communication methods but may also be by distributed communications. In the latter case, the access control point then can stand alone in a non-networked environment yet provide authorization functions and control of access to controlled spaces. The user is provided 36 with an access identification for presenting at the access control point, such as a coded ticket or other admission indicia.

The user subsequently seeks access 38 at one of the distributed access control points 16 having the scrubbed and encapsulated information. The information is correlated with the coded access identification and using the access logic permitted for the user, permits access to the controlled space or denies access 39. The control point communicates 40 through a feedback module 18 to the staging database 22 as to access control. Periodically, the feedback information communicates 42 to the core database 12 to update 30 the status of the entry granted or denied for the particular user. This provides validation of the entry by the user to the controlled space.

The present invention accordingly provides an apparatus 10 having individualized access validation at distributed access points 16. The request to access control space is authenticated by the access control modules 16, even though in an untethered environment (i.e., an environment where there is no active network connection at the time the access is sought). Rather, the core database 12 periodically downloads its extracted, scrubbed and encapsulated information to the distributed control points. Downloads may be based, for example, on a period of changes to the core database 12. The distributed access control modules 16 containing the scrubbed and encapsulated information process the request for access to controlled space at the non-networked access locations, but central control is maintained through the central core database 12 for consistency. This is accomplished by the periodic updates from the core database to the distributed module 16.

Further, the present invention provides asynchronous validation feedback through a feedback module 18. The feedback is maintained to provide for security checks and reporting of access authentications. In an exemplary embodiment, access authentications are binary: either denied or granted. While the scrubbed and encapsulated information maintained by the distribution module 16 are fundamental to the authentication access control at the access point, the scrubbed and encapsulated information contains no demographic information whereby a particular individual may be identified.

Authenticated access is accomplished by providing to the authorized individual an appropriate key mechanism that cooperatively correlates to the scrubbed and encapsulated module whereby single-use sought access to controlled space is granted. Counterfeit tickets or access indicia is thereby controlled with the present apparatus and method, as well as restricting use of a duplicate key. In the event that secondary or subsequent access is needed, supplemental access can be permitted by providing a supplemental control indicia to the user.

The present invention thus provides for personnel security for identity management and controlled access authentication and validation, particularly suitable for remote non-networked access control points requiring authentication prior to granting access with a feedback validation mechanism for tracking the access granted to the controlled location. In an exemplary embodiment, all data transmissions are secure and/or encrypted in compliance with federal and state laws applicable to the type of transaction. These laws include the Sarbanes-Oxley Act, the Granim-Leach-Bliley Act (GLBA), and the Health Insurance Portability and Accountability Act of 1996 (HIPAA).

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art, and variations and changes may be made by those skilled in the art without departing from the spirit of the invention. Accordingly, it is intended that the scope of the invention be defined by the claims appended hereto.

1. A system for distributed access control, comprising:
a. a content extraction control module operated by a computer process;
b. one or more distributed modules linked to the content extraction control module; and
c. one or more content storage devices linked to the content extraction control module.

2. The system of claim 1, wherein the content storage devices comprise one or more databases on a computer.

3. The system of claim 1, wherein said database contains demographic data and access control logic identifying persons authorized to have access to a control space.

4. The system of claim 1, wherein said distributed modules are distributed to one or more access control points.

5. The system of claim 4, wherein said access control points control access to one or more control spaces.

6. The system of claim 5, wherein access to said control space is obtained by presentation of a key at the access control point, where said key matches a lock in the distributed module controlling that access control point.

7. The system of claim 1, further comprising one or more feedback modules receiving data from said distributed modules.

8. The system of claim 7, wherein said data comprises asynchronous data feeds of authentication data.

9. The system of claim 7, further comprising one or more staging databases in electronic communication with said feedback modules.

10. The system of claim 9, wherein said staging database receives and stores authentication data from the distributed modules.

11. The system of claim 9, further comprising an integration module that receives authentication data from the staging database and sends the authentication data to the content storage device.

12. A method for providing distributed access control, comprising:
a. extracting and encapsulating access control information from a central database into a distributed module;
b. communicating said distributed module to one or more access control points;
c. receiving an access request from a prospective user at or through an access control point; and
d. evaluating the access request to determine if access by the prospective user is authorized.

13. The method of claim 12, further comprising:
a. communicating information regarding access authentication attempts to a feedback module; and
b. storing information regarding access authentication attempts in a staging database.

14. The method of claim 13, further comprising:
a. updating the central database with information regarding access authentication attempts.

15. The method of claim 12, wherein the prospective user is provided access identification information from the central database.
